(19) United States
(12) Patent Application Publication
(10) Pub. No.: US 2013/0138691 A1
(43) Pub. Date: May 30, 2013

(54) CUSTOMIZABLE MONITORING AND MANAGEMENT TOOL

(71) Applicant: Robert K. Floyd, III, Richmond, VT (US)

(72) Inventor: Robert K. Floyd, III, Richmond, VT (US)

(73) Assignee: INTERNATIONAL BUSINESS MACHINES CORPORATION, Armonk, NY (US)

(21) Appl. No.: 13/305,915

(22) Filed: Nov. 29, 2011

(51) Int. Cl. G06F 17/30

(52) U.S. Cl. 707/776; 707/E17.014

(57) ABSTRACT

A method, computer system and computer program product for collecting identified items of interest from text result output using a poller. The steps include identifying identified items of interest from a device through highlighting at least one portion of the text result output as data item of interest and recording a location of the at least one highlighted portion of the text result output identified as data items of interest, and at a set time interval accepted from the user, executing the poller, and if at least one data item of interest is present within the text result output, extracting and storing the at least one data item of interest in the repository.

### BACKGROUND

The present invention relates to customizable monitoring and management tools and more specifically to a computer network monitoring and management tool for recognizing user identified data output.

Within a network or network management system it is often desirable to monitor specific devices and observe data from a given subsystem of that system. In some cases, a network operator will require engagement with a different team to see if the desired data can be collected, increasing the software, hardware and labor in monitoring a network, especially if their knowledge of certain computer languages is limited.

For some networks, simple network management protocol (SNMP), a high level language, can be used to manage network infrastructure for conditions that warrant administrative attention within a system. Command and articulation of this language can be difficult and time consuming to teach network support personnel. SNMP relies on Management Information Base (MIB) structures to issue get and set commands. MIB strings are often complex, unique to each vendor, and can be incomplete in collecting device information, since some data points may not have a known MIB and can only be seen by issuing “show” or “output” commands on a device via a terminal shell. Furthermore, MIB strings are difficult to customize and mostly offer only generic or “canned” monitoring within the network management system.

### SUMMARY

According to one embodiment of the present invention, a method for collecting identified items of interest from text result output using a poller. The method comprises the steps of identifying identified items of interest from a device, which includes the steps of: a computer receiving a command entered into a text-based interface and storing the command into a repository; the computer executing the command entered into the text-based interface and displaying the text result output in the text-based interface; the computer accepting at least one highlighted portion of the text result output from a user, identifying text in the at least one highlighted portion as a data item of interest; the computer recording a location of the at least one highlighted portion of the text result output identified as data items of interest, associating the command with the data items of interest, and storing the location in the repository; the computer accepting a set time interval for execution of the command from the user; and at the set time interval accepted from the user, executing the poller, including the steps of: the computer executing the command and retrieving the text result output; the computer searching the text result output for identified items of interest based on the recorded location; if at least one data item of interest is present within the text result output, extracting and storing the at least one data item of interest in the repository.

According to another embodiment of the present invention, a computer program product for collecting identified items of interest from text result output using a poller. The computer program product includes one or more computer-readable, tangible storage devices; program instructions, stored on at least one of the one or more storage devices, to identify identified items of interest from a device, comprising: receiving a command entered into a text-based interface and storing the command into a repository; executing the command entered into the text-based interface and displaying the text result output in the text-based interface; accepting at least one highlighted portion of the text result output from a user, identifying text in the at least one highlighted portion as a data item of interest; recording a location of the at least one highlighted portion of the text result output identified as data items of interest, associating the command with the data items of interest, and storing the location in the repository; accepting a set time interval for execution of the command from the user; and program instructions, stored on at least one of the one or more storage devices, to at the set time interval accepted from the user, executing the poller, comprising: executing the command and retrieving the text result output; searching the text result output for identified items of interest based on the recorded location; if at least one data item of interest is present within the text result output, extracting and storing the at least one data item of interest in the repository.

According to another embodiment of the present invention, a computer system for collecting identified items of interest from text result output using a poller. The computer system includes one or more processors, one or more computer-readable memories and one or more computer-readable, tangible storage devices; program instructions, stored on at least one of the one or more storage devices for execution by at least one of the one or more processors via at least one of the one or more memories, to identify identified items of interest from a device, comprising: receiving a command entered into a text-based interface and storing the command into a repository; executing the command entered into the text-based interface and displaying the text result output in the text-based interface; accepting at least one highlighted portion of the text result output from a user, identifying text in the at least one highlighted portion as a data item of interest; recording a location of the at least one highlighted portion of the text result output identified as data items of interest, associating the command with the data items of interest, and storing the location in the repository; accepting a set time interval for execution of the command from the user; and program instructions, stored on at least one of the one or more storage devices for execution by at least one of the one or more processors via at least one of the one or more memories, to at the set time interval accepted from the user, executing the poller, comprising: executing the command and retrieving the text result output; searching the text result output for identified items of interest based on the recorded location; if at least one data item of interest is present within the text result output, extracting and storing the at least one data item of interest in the repository.

### BRIEF DESCRIPTION OF THE SEVERAL VIEWS OF THE DRAWINGS

FIG. 1 shows depicts a pictorial representation of a network of computers in which illustrative embodiments may be implemented.

FIG. 2 shows an example of an issued command and highlighted identified items of interest for output capture of a first embodiment.

FIG. 3 shows an example of a customizable poller command for inventory capture of a second embodiment.

FIG. 4 shows a method of customizing a poller to collect identified items of interest from text result output.

FIG. 5 shows illustrates internal and external components of a client computer and a server computer in which illustrative embodiments may be implemented.

### DETAILED DESCRIPTION

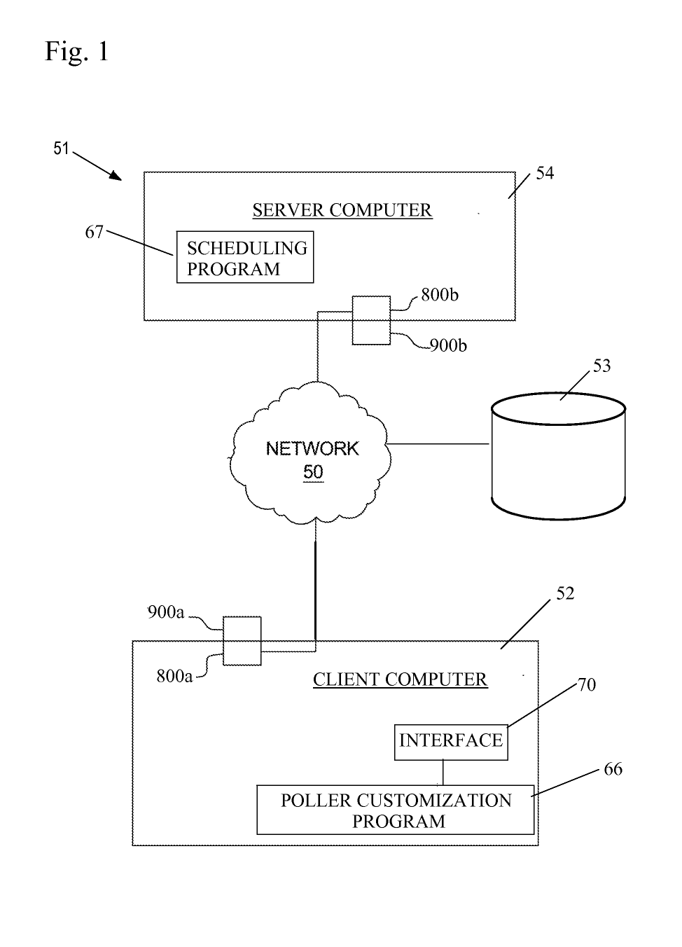

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

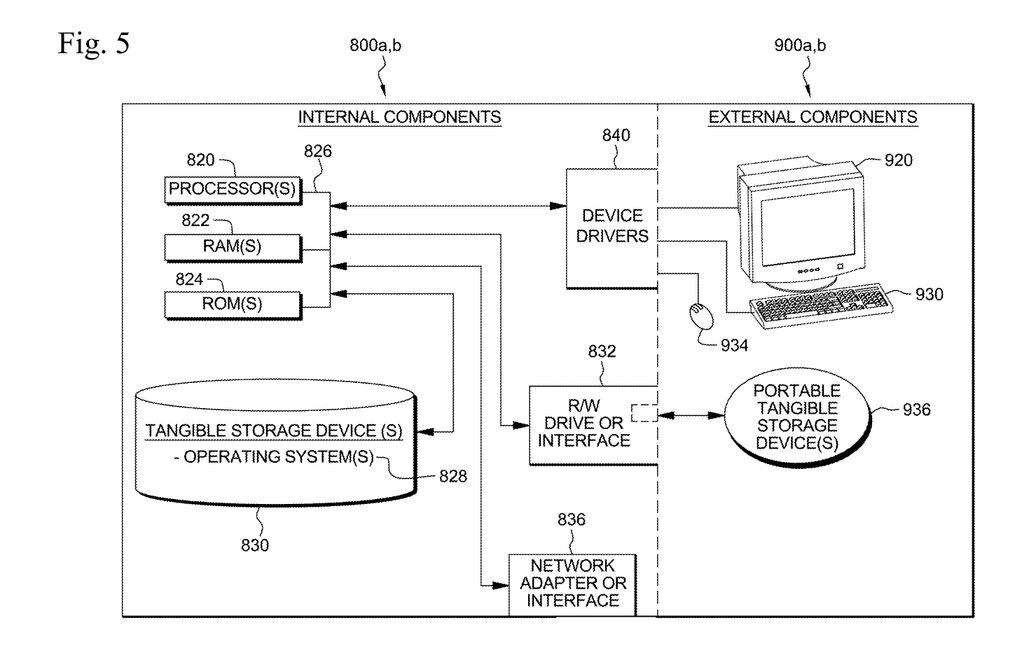

In the depicted example, client computer 52, tangible storage device 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 5. Client computer 52 may be, for example, a mobile device, a cell phone, a personal digital assistant, a netbook, a laptop computer, a tablet computer, a desktop computer, or any other type of computing device. Client computer 52 may contain an interface 70. The interface 70 may accept commands and data entry from a user as well as display output results. The interface 70 can be, for example, a command line interface, a graphical user interface (GUI), or a web user interface (WUI) through which a user can access a network including a poller customization program 66 on either client computer 52 or server computer 54. Server computer 54 includes a set of internal components 800b and a set of external components 900b illustrated in FIG. 5.

In the depicted example, server computer 54 provides information, such as boot files, operating system images, and applications to a client computer 52. Server computer 54 can compute the information locally or extract the information from other computers on network 50. The server computer 54 may contain a scheduling program 67 for executing or running programs at specific times and intervals.

Program code and programs such as a poller customization program 66 may also be located in network data processing system 51 and may be stored on at least one of one or more computer-readable tangible storage devices 830 shown in FIG. 5, on at least one of one or more portable computer-readable tangible storage devices 936 as shown in FIG. 5, on tangible storage device 53 connected to network 50, or downloaded to a data processing system or other device for use. For example, program code and programs such as a poller customization program 66 may be stored on at least one of one or more tangible storage devices 830 on server computer 54 and downloaded to client computer 52 over network 50 for use on client computer 52. Alternatively, server computer 54 can be a web server, and the program code, and programs such as an a poller customization program 66 and a scheduling program 67 may be stored on at least one of the one or more tangible storage devices 830 on server computer 54 and accessed on client computer 52. In other exemplary embodiments, the program code, and programs such as a poller customization program 66 and a scheduling program 67 may be stored on at least one of one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

In an embodiment of the present invention, a network management tool with a customizable poller program provides support personnel or a user with a means to manage network devices by recording interactions between the user and the remote device being managed. The tool may be provided by the same vendor as one or more of the computers on the network, or by a third-party vendor, and thus is referred to herein as “independent from a specific vendor”.

A user, through an interface 70, establishes a text-based session (for example, telnet or secure shell (ssh)) from within the interface to securely access the network data processing system 51, most likely through a login. The login information may contain, but is not limited to, IP address or Hostname, User ID, password, privilege access enablement, and terminal operations to set screen length and width. The user can save the login parameters as a template for later or other command executions.

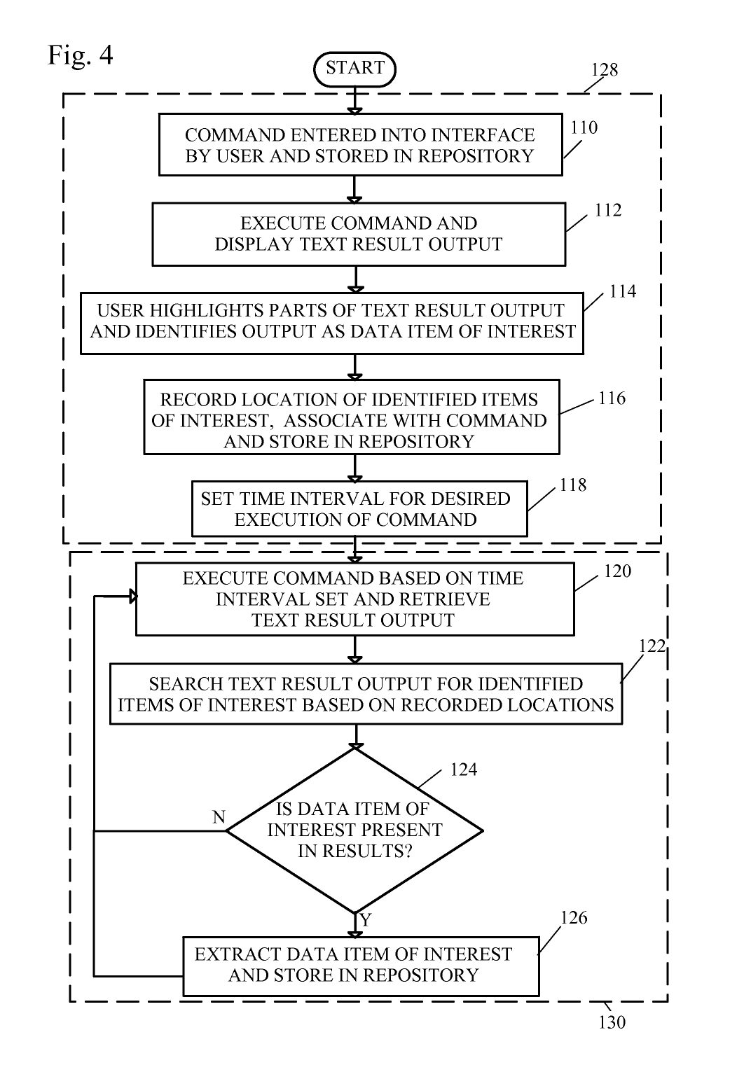

Referring to FIG. 4, once a user is logged into the network data processing system 51 and/or a device within the network data processing system 51, the user enters a command into a text based command interface and the command is stored in a repository (step 110).

The command entered into the text-based command interface is executed and displays results that match the command as text output to the user (step 112). The execution of the command may be carried out by the poller customization program 66 or another program within the network data processing system 51 itself.

The user, for example through the poller customization program 66, highlights parts of the text output and identifies or tags the output highlighted as a data item of interest (step 114).

The poller customization program 66 records the location of the identified items of interest and associates the identified items of interest with the executable command, and stores the information in a repository (step 116), for example repository 53 of FIG. 1 or tangible storage devices 830, 936 of FIG. 5. The recordation of the location of the identified items of interest may include, but is not limited to, a line number where the highlighted text is located, a white space count on a line where highlighted text is located, a leading text string prior to highlighted text, a tailing text string after highlighted text, an alphanumeric or number expected in highlighted text area, or a pattern match string the operator may explicitly specify for capture.

The user, through the customization poller program 66 or a scheduling program 67 of the web server, indicates a time interval for desired execution of the command (step 118). The time interval may be set in minutes, hours, days or weeks (and, if desired, a number of times to execute), and a stop date and a time can also be provided at which login and issue of the operation of the command ceases.

It should be noted that steps 110-118 within dashed box 128 are steps for setting up and customizing the poller or determining the command and data items of interest. Steps 120-126 within dashed box 130 discussed further below may be iterated continuously as long as the user designates.

The network data processing system 51, through the customization poller program 66 or another program within the network data processing system 51, executes the command based on the time interval set and retrieves the text result output (step 120). The customization poller program 66 searches the text result output for the identified items of interest based on the recorded location of the identified items of interest (step 122). If a data item of interest is present within the text output (step 124), extract data item of interest and store in a repository (step 126) and the method ends.

If a data item of interest is not present within the text result output (step 124), return to step 120 of the system executing the command based on a time interval set by the user and retrieve text result output.

In addition to the data item of interest, other information such as device accessed, capture filter name, and time accesses may also be recorded and stored within the repository. The information other than the data item of interest stored within the repository based on the text result output may be customized and specified by the user. Furthermore, the command and/or the highlighted data items of interest may be updated or changed at any time to reflect the changing needs of the user.

The information stored in the repository may be inserted into a graphics program to graphically alter and/or displayed graphically to a user the operational behavior of a device to a user.

The command and associated items of interest may be applied to more than one device within the network data processing system 51 and stored in the one repository or separate repositories for each device. The commands to multiple devices may be run simultaneously.

The command and highlighted portions of the text result output may be stored a template to be applied to other devices within the network data processing system 51.

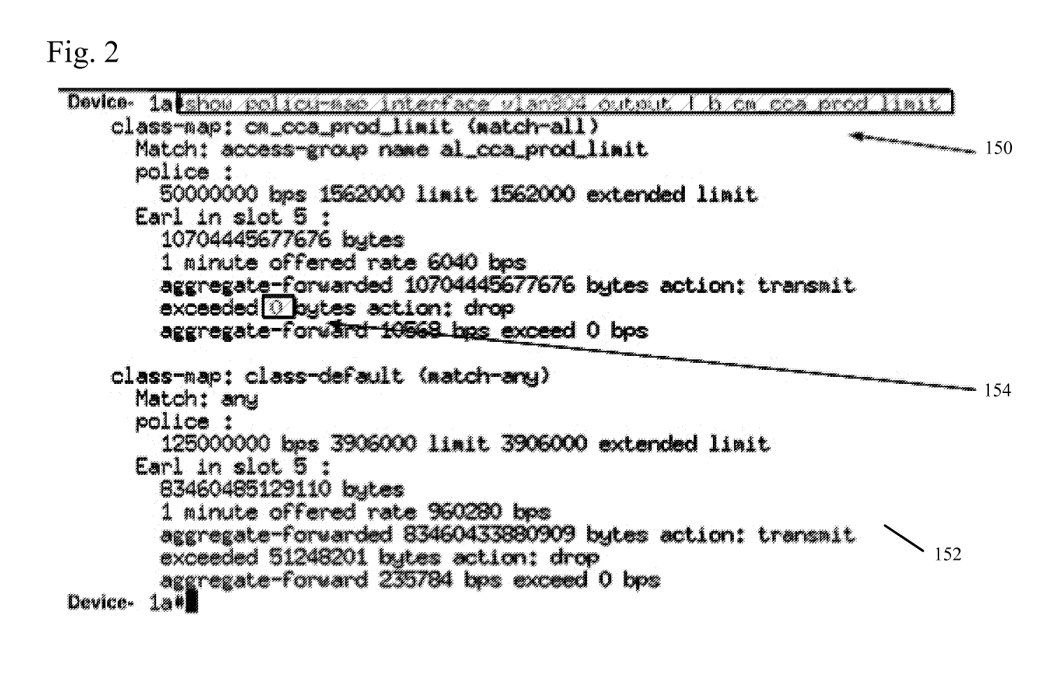

FIG. 2 shows an example of an issued command and highlighted identified items of interest for output capture to collect operational data of a first embodiment.

If a user had a need to investigate whether packets are being dropped due to rate limiting for a device, the following command 150 may be entered:

show policy-map interface vlan904 output l b cm_ccaprod_limit

The text result output is displayed below the command and is indicated by reference number 152. The user highlights parts of the text result output 152 (as indicated by cross-hatched area 154) and identifies the highlighted output as a data item of interest. In this example, the bytes being dropped are of interest, and are therefore highlighted. The location of the highlighted text result output is associated with the command 150 entered by the user and stored in a repository.

The user would then set a time interval for the command to run for this device (and, if desired, a number of times to execute), and the tool would store the data items of interest in the repository at each interval. A user at a later time can review the stored data items of interest to determine whether packets are being dropped over the set time period.

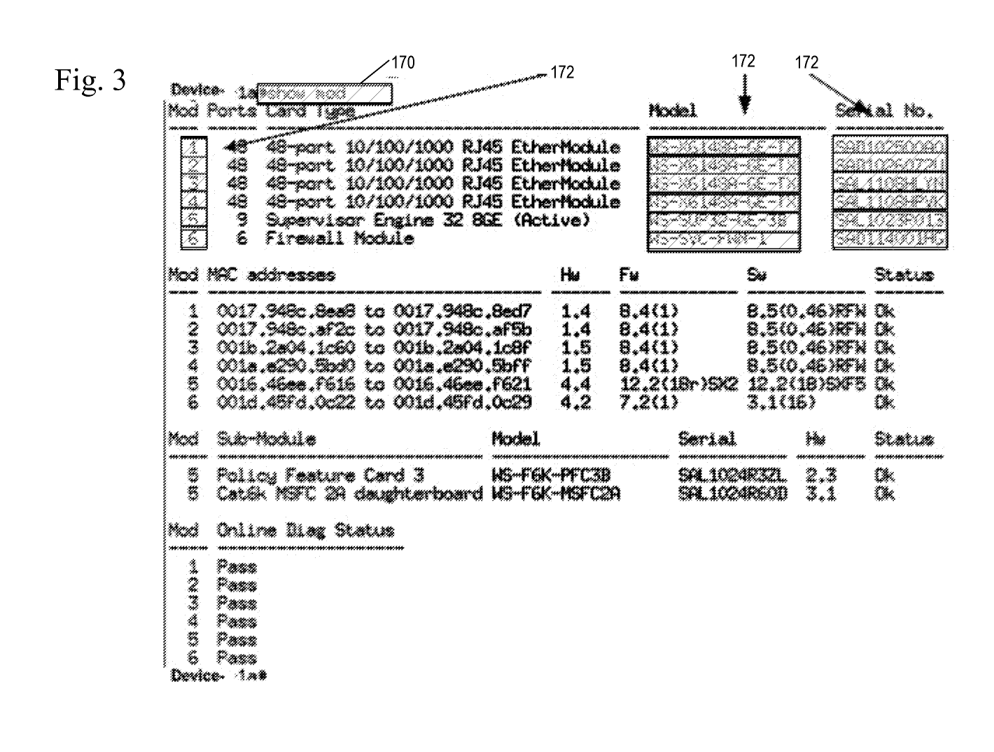

FIG. 3 shows an example of a customizable poller command for inventory capture of a second embodiment. If a user wants to track assets within a system, the following command 170 may be entered:

#show mod

Multiple fields 172 are then highlighted by the user as identified items of interest, for example the module number, the model and the serial number, indicated by reference number. The location of the highlighted fields 172 are recorded and associated with the command 170 within a repository. The highlights fields may be labeled as a predefined set or with a custom label by a user to create a module in which can be applied to other devices.

As above, the user would then set a time interval for the command to run for this device (and, if desired, a number of times to execute), and the tool would store the data items of interest in the repository at each interval. A user at a later time can review the stored data items of interest to determine whether device inventory has changed over the time period.

FIG. 5 illustrates internal and external components of client computer 52 and server computer 54 in which illustrative embodiments may be implemented. In FIG. 10, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and search model programs 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A customization poller program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A customization poller program 66 can be downloaded to computer 52 and server computer 54 from an external computer via a network (for example, the Internet, a local area network or other, wide area network) and network adapter or interface 836. From the network adapter or interface 836, a customization poller program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 940. Each of the sets of internal components 800a, 800b also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

A customization poller program 66 can be written in various programming languages including low-level, high-level, object-oriented or non object-oriented languages. Alternatively, the functions of a customization poller program 66 can be implemented in whole or in part by computer circuits and other hardware (not shown).

Based on the foregoing, a computer system, method and program product have been disclosed for a method of collecting identified items of interest from text result output using a poller. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for collecting identified items of interest from text result output using a poller, the method comprising the steps of:
identifying identified items of interest from a device, comprising the steps of:
a computer receiving a command entered into a text-based interface and storing the command into a repository;
the computer executing the command entered into the text-based interface and displaying the text result output in the text-based interface;
the computer accepting at least one highlighted portion of the text result output from a user, identifying text in the at least one highlighted portion as a data item of interest;
the computer recording a location of the at least one highlighted portion of the text result output identified as data items of interest, associating the command with the data items of interest, and storing the location in the repository;
the computer accepting a set time interval for execution of the command from the user;
at the set time interval accepted from the user, executing the poller, comprising the steps of, the computer executing the command and retrieving the text result output;
the computer searching the text result output for identified items of interest based on the recorded location;
extracting and storing the at least one data item of interest from the recorded location within the text result output into the repository.

2. The method of claim 1, wherein the location of the identified items is identified by a line number where the at least one highlighted portion of the text result output is located, a white space count on a line where the highlighted portions of the text result output is located, a leading text string prior to the highlighted portions of the text result output, a tailing text string after the highlighted portions of the text result output, an alphanumeric or number expected in the highlighted portions of the text result output, or a pattern match string the user explicitly specifies for capture.

3. The method of claim 1, wherein the step of executing the poller is repeated for a time period designated by the user.

4. The method of claim 1, wherein the set time interval for execution of the command from the user includes a stop time.

5. The method of claim 1, wherein the set time interval for execution of the command from the user includes a number of times in which to execute the command during the set time interval.

6. The method of claim 1, wherein a plurality of highlighted portions of the text result output are grouped together to form a module.

7. A computer program product comprising one or more computer-readable, tangible storage devices and computer-readable program instructions which are stored on the one or more storage devices and when executed by one or more processors, implement all the steps of claim 1.

8. A computer system comprising one or more processors, one or more computer-readable memories, one or more computer-readable, tangible storage devices and program instructions which are stored on the one or more storage devices for execution by the one or more processors via the one or more memories and when executed by the one or more processors implement all the steps of claim 1.

9. A computer program product for collecting identified items of interest from text result output using a poller, the computer program product comprising:
one or more computer-readable, tangible storage devices;
program instructions, stored on at least one of the one or more storage devices, to identify identified items of interest from a device, comprising:
receiving a command entered into a text-based interface and storing the command into a repository;
executing the command entered into the text-based interface and displaying the text result output in the text-based interface;
accepting at least one highlighted portion of the text result output from a user, identifying text in the at least one highlighted portion as a data item of interest;
recording a location of the at least one highlighted portion of the text result output identified as data items of interest, associating the command with the data items of interest, and storing the location in the repository;
accepting a set time interval for execution of the command from the user;
program instructions, stored on at least one of the one or more storage devices, to at the set time interval accepted from the user, executing the poller, comprising:
executing the command and retrieving the text result output;
searching the text result output for identified items of interest based on the recorded location;
extracting and storing the at least one data item of interest from the recorded location within the text result output into the repository.

10. The computer program product of claim 9, wherein the location of the identified items is identified by a line number where the at least one highlighted portion of the text result output is located, a white space count on a line where the highlighted portions of the text result output is located, a leading text string prior to the highlighted portions of the text result output, a tailing text string after the highlighted portions of the text result output, an alphanumeric or number expected in the highlighted portions of the text result output, or a pattern match string the user explicitly specifies for capture.

11. The computer program product of claim 9, wherein the program instructions of executing the poller is repeated for a time period designated by the user.

12. The computer program product of claim 9, wherein the set time interval for execution of the command from the user includes a stop time.

13. The computer program product of claim 9, wherein the set time interval for execution of the command from the user includes a number of times in which to execute the command during the set time interval.

14. The computer program product of claim 9, wherein a plurality of highlighted portions of the text result output are grouped together to form a module.

15. A computer system for collecting identified items of interest from text result output using a poller, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to identify identified items of interest from a device, comprising:
receiving a command entered into a text-based interface and storing the command into a repository;
executing the command entered into the text-based interface and displaying the text result output in the text-based interface;
accepting at least one highlighted portion of the text result output from a user, identifying text in the at least one highlighted portion as a data item of interest;
recording a location of the at least one highlighted portion of the text result output identified as data items of interest, associating the command with the data items of interest, and storing the location in the repository;
accepting a set time interval for execution of the command from the user;
program instructions, stored on at least one of the one or more storage devices for execution by at least one of the one or more processors via at least one of the one or more memories, to at the set time interval accepted from the user, executing the poller, comprising:
executing the command and retrieving the text result output;
searching the text result output for identified items of interest based on the recorded location;
extracting and storing the at least one data item of interest from the recorded location into the repository.

16. The system of claim 15, wherein the location of the identified items is identified by a line number where the at least one highlighted portion of the text result output is located, a white space count on a line where the highlighted portions of the text result output is located, a leading text string prior to the highlighted portions of the text result output, a tailing text string after the highlighted portions of the text result output, an alphanumeric or number expected in the highlighted portions of the text result output, or a pattern match string the user explicitly specifies for capture.

17. The system of claim 15, wherein the program instructions of executing the poller is repeated for a time period designated by the user.

18. The system of claim 15, wherein the set time interval for execution of the command from the user includes a stop time.

19. The system of claim 15, wherein the set time interval for execution of the command from the user includes a number of times in which to execute the command during the set time interval.

20. The system of claim 15, wherein a plurality of highlighted portions of the text result output are grouped together to form a module.
